(19) United States
(12) Patent Application Publication
(10) Pub. No.: US 2008/0101694 A1
(43) Pub. Date: May 1, 2008

(54) AUTO COLOR CONTROL CIRCUIT AND VIDEO SIGNAL PROCESSING CIRCUIT

(75) Inventor: Yasuhiko Kitamura, Saitama (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/926,947

(22) Filed: Oct. 29, 2007

(30) Foreign Application Priority Data
Oct. 30, 2006 (JP) 2006-294852

(51) Int. Cl. G06K 9/00

(52) U.S. Cl. 382/167

(57) ABSTRACT

An auto color control circuit comprises an auto color control wave detecting unit configured to detect the amplitude of a burst signal contained in a carrier chrominance signal and to output the amplitude as an auto color control wave detection signal; a hysteresis signal generating unit configured to output a hysteresis signal having hysteresis characteristics depending on the level of said auto color control wave detection signal; and a gain varying unit configured to variably control the gain of said carrier chrominance signal according to said hysteresis signal.

### CROSS REFERENCE TO RELATED APPLICATION

This application is based upon and claims the benefit of priority from the prior Japanese Patent Application No. 2006-294852 filed on Oct. 30, 2006; the entire contents of which are incorporated herein by reference.

### BACKGROUND OF THE INVENTION

1. Field of the Invention

The present invention relates to an auto color control circuit and a video signal processing circuit configured to control the amplitude of a carrier chrominance signal of a color television signal.

2. Description of the Related Art

In a color television receiver, when a reception channel is switched, or when a received radio wave varies or a failure occurs in an antenna system, the level of a carrier chrominance signal changes relative to a luminance signal and the color strength of a screen changes.

In order to prevent the above phenomenon from happening, a color television receiver is provided with an auto color control circuit (hereinafter, referred to as an ACC circuit). The ACC circuit maintains a constant level of a carrier chrominance signal using an ACC wave detection output of an ACC wave detecting circuit.

For example, an ACC circuit according to a prior art disclosed in Japanese Patent Publication No. 5-72797 detects an average value of a burst signal in a digitized chroma signal from the maximum value and the minimum value thereof, compares the average value to the reference value using a hysteresis type comparator, and supplies the comparison result of positive or negative to a control terminal of a reversible counter.

If the average value is within a pre-determined range near the reference value, the circuit controls an ACC loop by comparison to an integration value of the average value integrated by a vertical interval. The circuit performs the comparison for each horizontal pulse until the average value comes near to the pre-determined range.

The ACC circuit according to the above prior art performs the comparison for each horizontal pulse until the average value comes near to the pre-determined range. However, in the pre-determined range in which the average value is near the reference value, the circuit performs the comparison using an integration value in a vertical interval, and therefore the responsiveness decreases.

For example, if the level of a carrier chrominance signal changes in an interval shorter than a vertical interval (in switching of a reception channel, for example) in a pull-in state in which the average value is within the pre-determined range near the reference value, the ACC circuit performs the comparison using an integration value of a vertical interval. As such, the circuit has a drawback in that the responsiveness decreases.

### SUMMARY OF THE INVENTION

According to an aspect of the invention, there is provided an auto color control circuit according to one embodiment of the present invention includes: an auto color control wave detecting unit configured to detect amplitude of a burst signal contained in a carrier chrominance signal and to output the amplitude as an auto color control wave detection signal; a hysteresis signal generating unit configured to output a hysteresis signal having hysteresis characteristics depending on level of said auto color control wave detection signal; and a gain varying unit configured to variably control gain of said carrier chrominance signal according to said hysteresis signal.

According to an another aspect of the invention, there is provided a color television receiver according to one embodiment of the present invention includes an auto color control circuit including: an auto color control wave detecting unit configured to detect amplitude of a burst signal contained in a carrier chrominance signal and to output the amplitude as an auto color control wave detection signal; a hysteresis signal generating unit configured to output a hysteresis signal having hysteresis characteristics depending on level of said auto color control wave detection signal; and a gain varying unit configured to variably control gain of said carrier chrominance signal according to said hysteresis signal.

### BRIEF DESCRIPTION OF THE DRAWINGS

FIG. 1 is a block diagram illustrating configuration of an ACC circuit according to one embodiment of the present invention;

FIG. 2 is a block diagram illustrating an example of the configuration of the ACC circuit according to the embodiment;

FIG. 3 is a characteristic diagram illustrating input/output characteristics having hysteresis of a hysteresis signal generating unit;

FIGS. 4A to 4D illustrate operations of waveforms of respective units when a low-amplitude input signal is pulled in a pre-determined level;

FIGS. 5A to 5D illustrate operations of waveforms of the respective units when a high-amplitude input signal is pulled in a pre-determined level;

FIGS. 6A to 6D illustrate operations of waveforms of the respective units when a single-shot noise occurs;

FIG. 7 is a block diagram illustrating a configuration example of an ACC circuit in a reference example;

FIGS. 8A to 8E illustrate operations of waveforms of the respective units influenced by the accuracy of gain control in the reference example;

FIGS. 9A to 9D illustrate operations of waveforms of the respective units when a single-shot noise occurs in the reference example;

FIG. 10 is a block diagram illustrating a configuration example of an ACC circuit provided in a color signal processing circuit according to a variation example;

FIG. 11 is a characteristic diagram illustrating a gain variation suppression range of a hysteresis signal generating unit in addition to input/output characteristics; and

FIG. 12 is a block diagram illustrating a configuration of a video signal processing circuit including the color signal processing circuit.

### DETAILED DESCRIPTION OF PREFERRED EMBODIMENT

The following will describe an embodiment of the present invention with reference to the drawings.

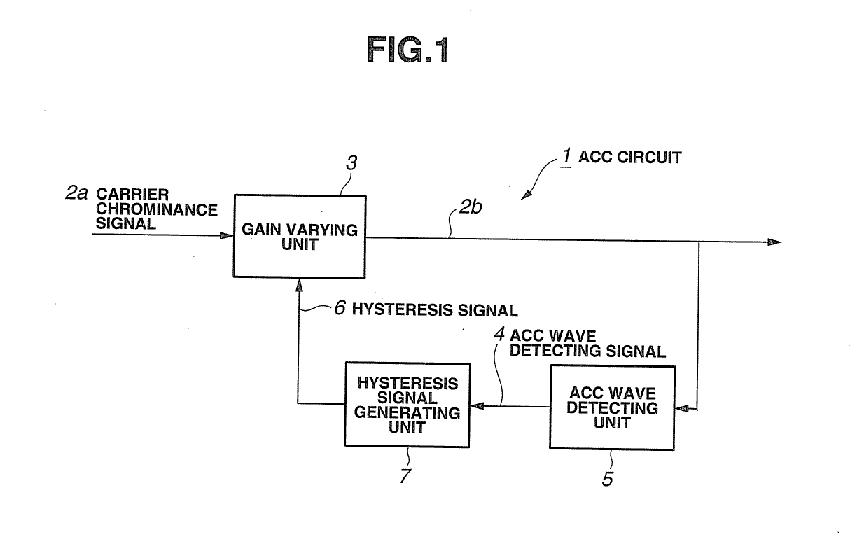

FIG. 1 is a block diagram illustrating basic configuration of an auto color control circuit (hereinafter, referred to as an ACC circuit) 1 according to one embodiment of the present invention.

The ACC circuit 1 includes a gain varying unit 3 configured to amplify a carrier chrominance signal 2a inputted as an input signal. A carrier chrominance signal 2b, which has been amplified by the gain varying unit 3 such that the gain is variable, is inputted to an ACC wave detecting unit 5 configured to detect the amplitude of a burst signal in the carrier chrominance signal 2b and to output the amplitude as an ACC wave detection signal 4.

The ACC wave detection signal 4 outputted from the ACC wave detecting unit 5 is inputted to a hysteresis signal generating unit 7 configured to output a hysteresis signal 6 having hysteresis characteristics.

The hysteresis signal 6 outputted from the hysteresis signal generating unit 7 is applied as a signal to variably control the gain in the gain varying unit 3. The gain varying unit 3 amplifies the inputted carrier chrominance signal 2a with hysteresis characteristics depending on the hysteresis signal 6.

The gain varying unit 3 outputs the carrier chrominance signal 2b amplified by auto color control (ACC) as an output signal from the ACC circuit 1 to the post-stage.

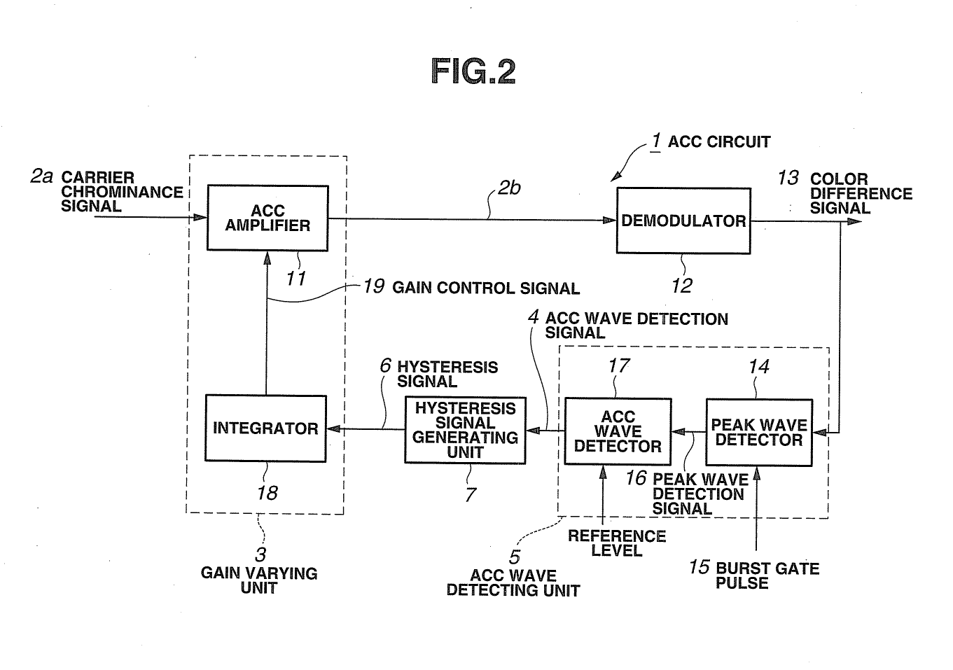

In the configuration in FIG. 1, the carrier chrominance signal 2b outputted from the gain varying unit 3 may be inputted to a demodulating circuit (not shown). Alternatively, a demodulating circuit 12 may be arranged between the gain varying unit 3 and the ACC wave detecting unit 5, as shown in FIG. 2.

FIG. 2 illustrates a configuration example of the ACC circuit 1 according to the embodiment of the present invention in further detail.

The carrier chrominance signal 2a is inputted to an ACC amplifier circuit 11 configuring the gain varying unit 3. The gain in the ACC amplifier circuit 11 when an input signal is amplified is controlled by a signal applied to a gain control terminal. The carrier chrominance signal 2b amplified by the ACC amplifier circuit 11 is inputted to the demodulating circuit 12.

The demodulating circuit 12 demodulates the carrier chrominance signal 2b and outputs a color difference signal 13. The color difference signal 13 is outputted from the ACC circuit 1 and inputted to a peak wave detecting circuit 14 configuring the ACC wave detecting unit 5.

The peak wave detecting circuit 14 detects the amplitude of a burst signal contained in the color difference signal 13. A burst signal is used as a reference signal to demodulate a color signal.

A burst gate pulse 15 synchronized with the burst signal is inputted to the peak wave detecting circuit 14 as a gate pulse to detect the peak of a wave.

Then, the peak wave detecting circuit 14 detects the peak value of the burst signal in a gate interval during which the burst gate pulse 15 has been inputted and outputs the value as a peak wave detection signal 16. The burst gate pulse 15 is set, for example, within a signal interval around the middle of an interval during which the burst signal is inputted excluding the both ends of the interval.

Although an example of detection of the peak value of a burst signal and output of the value as a peak wave detection signal is described as one example of detection of the amplitude of a burst signal (a signal equivalent to the amplitude) in the present embodiment, the present invention is not limited to the example. As another example, the maximum value and the minimum value of a burst signal are obtained, for example, so that an average value of the values can be a wave detection signal corresponding to the amplitude of the burst signal.

The peak wave detection signal 16 is inputted to an ACC wave detecting circuit 17. The ACC wave detecting circuit 17 compares the inputted peak wave detection signal 16 to the reference level (reference value) and outputs a signal that can have positive or negative polarity corresponding to the deviation from the reference level as the ACC wave detection signal 4.

The ACC wave detection signal 4 is inputted to the hysteresis signal generating unit 7. The hysteresis signal 6 outputted from the hysteresis signal generating unit 7 is inputted to an integrating circuit 18 configuring the gain varying unit 3.

The integrating circuit 18 integrates the inputted hysteresis signal 6 on an appropriate cycle and applies the result as a gain control signal 19 to a gain control terminal of the ACC amplifier circuit 11. The integrating circuit 18 can perform integration on any cycle not less than a horizontal interval, as can be seen from the operation described later (since the circuit 18 has a function to hold a gain control signal in the previous horizontal interval).

The circuit 18 can be set to integrate on an arbitrary cycle such as a cycle about a horizontal interval or a cycle of a few horizontal intervals, for example, only if the above condition is satisfied. Alternatively, a low-pass filter circuit can be used instead of the integrating circuit 18.

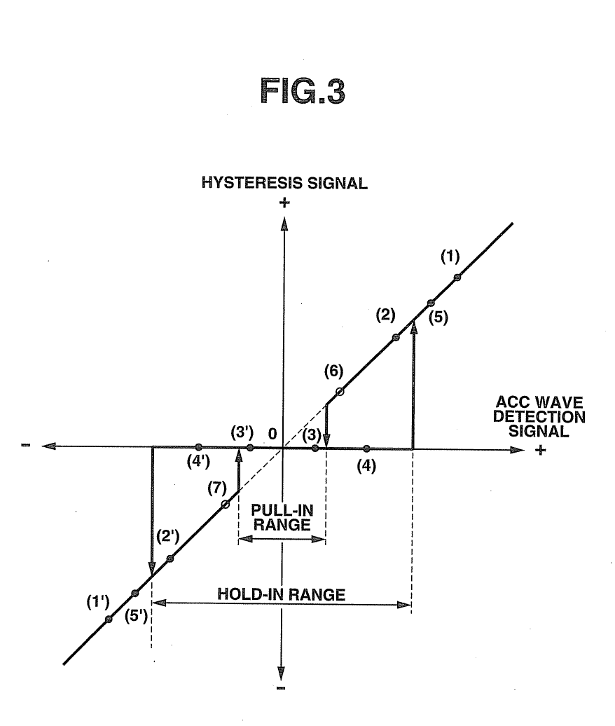

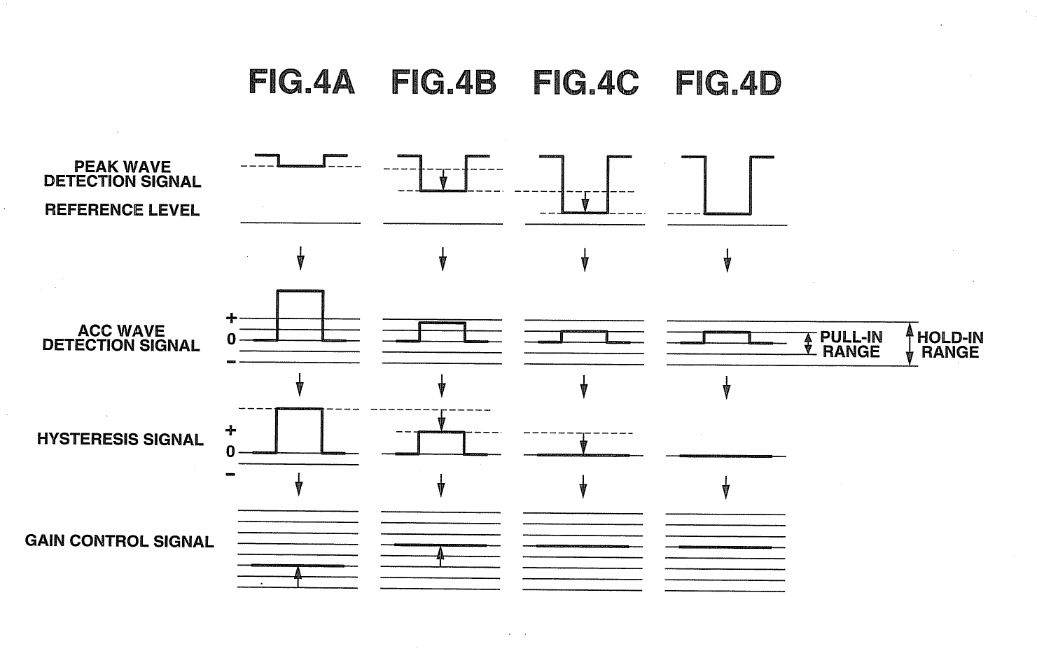

Input/output characteristics of the hysteresis signal generating unit 7 have the hysteresis characteristics, as shown in FIG. 3. In the following description, the peak wave detection signal 16 has negative polarity that the higher the amplitude of a burst signal, the lower the signal 16, as described in relation to FIG. 4A and others (symbols such as “4” of the ACC wave detection signal 4 and others are omitted in FIG. 3, FIGS. 4A to 4D, FIGS. 5A to 5D and FIGS. 6A to 6D).

The following description is also based on an example that the higher the level of the gain control signal 19, the smaller the gain of the ACC amplifier circuit 11.

The hysteresis signal generating unit 7 takes the ACC wave detection signal 4 on the abscissa axis in FIG. 3 as an input signal and outputs the hysteresis signal 6 on the ordinate axis.

If the hysteresis signal generating unit 7 does not have hysteresis characteristics, the ACC wave detection signal 4 has linear input/output characteristics that the value of the reference level is zero, i.e., passes the origin 0, as shown by a dotted line in FIG. 3. However, the hysteresis signal generating unit 7 actually has input/output characteristics as shown by a solid line depending on a past state of an input signal due to the hysteresis characteristics.

Specifically, if the ACC wave detection signal 4 changes toward the reference level, for example, changes as shown by symbols (1), (2) and (3) in the example in FIG. 3, then the signal exhibits the linear input/output characteristics depending on the value of the ACC wave detection signal 4 on the outside of a pull-in range, i.e. at the symbols (1) and (2). In that case, the hysteresis signal 6 is not 0.

Meanwhile, if the ACC wave detection signal 4 is within the pull-in range as shown by the symbol (3), the hysteresis signal 6 is 0. In FIG. 3, if the signal 4 changes from the symbol (2) toward the symbol (3), the signal 4 changes as shown by an arrow on the boundary of the pull-in range on the way and the hysteresis signal 6 is 0.

If the ACC wave detection signal 4 changes from the inside of the pull-in range toward the outside of the pull-in range, for example, changes as shown by symbols (3), (4) and (5) in the example in FIG. 3, then the hysteresis signal 6 holds the value 0 within a hold-in range as a second range being set on the outside of the pull-in range.

Meanwhile, if the ACC wave detection signal 4 is on the outside of the hold-in range, the hysteresis signal 6 changes according to the linear input/output characteristics of not being 0 (i.e., depending on a value of the ACC wave detection signal 4).

As such, the hysteresis signal generating unit 7 includes two window comparators 7a and 7b configured to perform comparison to determine whether the inputted ACC wave detection signal 4 is a reference level within the pull-in range or a reference level within the hold-in range.

The hysteresis signal generating unit 7 also includes a holding circuit 7c configured to temporarily hold the inputted ACC wave detection signal 4. A value held in the holding circuit 7c is also compared to the next inputted ACC wave detection signal 4 to be referenced for decision of output characteristics of the ACC wave detection signal 4.

As described above, the hysteresis signal generating unit 7 is set to exhibit the hysteresis characteristics in the pull-in range as a first range being set for narrower range values around the reference level as the median value, and the hold-in range as a second range being set on the outside of the pull-in range (around the reference level as the median value).

The pull-in range and the hold-in range are not limited to ranges symmetrical to each other about the abscissa axis taking the reference level as the median value.

Values in the pull-in range and the hold-in range can be variably set depending on characteristics of a color television receiver equipped with the ACC circuit 1.

In the present embodiment, the ACC circuit 1 performs ACC through a closed loop, as can be seen from FIG. 2. The closed loop performs the ACC operation on a pre-determined cycle (more specifically, an operation to automatically control the amplitude of a carrier chrominance signal or the color difference signal 13 as an output signal of a demodulating unit 12 such that the ACC wave detection signal 4 holds an amplitude level near to the reference level).

The pre-determined cycle can be set to around a horizontal interval, for example. In that case, a response can be returned quickly.

Next, the operation of the ACC circuit 1 according to the present embodiment will be described.

FIGS. 4A to 4D illustrate the operation to pull too low amplitude of the peak wave detection signal 16 corresponding to the carrier chrominance signal 2a as an input signal in a proper level.

First, in the state in FIG. 4A, the peak wave detection signal 16 does not reach the reference level, that is, the gain of the ACC amplifier circuit 11 is insufficient.

In that state, the ACC wave detection signal 4 outputted from the ACC wave detecting unit 5 is a positive value on the outside of the hold-in range, for example. The ACC wave detection signal 4 is inputted as a signal equivalent to the symbol (1) in FIG. 3 to the hysteresis signal generating unit 7, and a value on the ordinate axis corresponding to the signal, or the hysteresis signal 6 being a positive value in this case is generated.

The hysteresis signal 6 is integrated by the integrating circuit 18 and increases the gain control signal 19, so that the signal 6 serves to increase the gain of the ACC amplifier circuit 11. As a result, the amplitude of the peak wave detection signal 16 becomes higher in the next cycle (for example, a horizontal interval) as in FIG. 4B.

However, in this example, the signal 6 is the positive ACC wave detection signal 4 as shown in FIG. 4B because the signal 6 has not reached the reference level yet. The ACC wave detection signal 4 is inputted as a signal, for example, equivalent to the symbol (2) in FIG. 3 to the hysteresis signal generating unit 7.

In the above case, the value of the ACC wave detection signal 4 is smaller than the value of the symbol (1) in FIG. 3, and is a value for example, within the hold-in range and on the outside of the pull-in range. As such, the hysteresis signal generating unit 7 generates a value on the ordinate axis in this case, i.e. the hysteresis signal 6 being a positive value. The hysteresis signal 6 is a positive value smaller than that in FIG. 4A, so that the signal 6 increases the gain control signal 19 as shown in FIG. 4B.

As such, similarly to the operation described before, the gain control signal 19 operates to increase the gain of the ACC amplifier circuit 11 and transits to FIG. 4C. Since the peak wave detection signal 16 has not yet reached the reference level also in that state, the positive ACC wave detection signal is inputted to the hysteresis signal generating unit 7.

In the above case, when the ACC wave detection signal 4 is within the pull-in range in the hysteresis signal generating unit 7, the signal 4 is inputted as a signal equivalent to the symbol (3) in FIG. 3. In that case, the hysteresis signal 6 of a value 0 is generated as shown in FIG. 3. Accordingly, the gain control signal 19 has a value shown in FIG. 4C same as shown in FIG. 4B.

In the above case, the state in the previous cycle (the state in FIG. 4C) for the gain in the ACC amplifier circuit 11 is held, so that the gain is the peak wave detection signal 16 shown in FIG. 4D. Afterward, the ACC wave detection signal 4, the hysteresis signal 6 and the gain control signal 19 shown in FIG. 4D in the same state as in FIG. 4C will be kept.

FIGS. 4A to 4D illustrate representative processes in which the ACC wave detection signal 4 changes from the outside of the hold-in range into the pull-in range. In practice, there are also intermediate processes between the representative processes. The same is true on other drawings.

As described with reference to FIGS. 3, 4A and others, if the carrier chrominance signal 2a of a low amplitude is inputted as an input signal, the ACC circuit 1 according to the present embodiment controls the gain of the ACC wave detection signal 4 such that the signal 4 gets close to the reference level by an ACC loop.

Then, if the ACC wave detection signal 4 reaches the pull-in range in the hysteresis signal generating unit 7 (being set in the vicinity of the reference level), the ACC circuit 1 sets the hysteresis signal 6 to 0. This can effectively prevent the occurrence of an ACC flicker in an ACC circuit not including the hysteresis signal generating unit 7 (described later), thereby realizing stable ACC loop operation.

The operation has been described in relation to FIGS. 4A to 4D in which the ACC wave detection signal 4 is pulled in the pull-in range in the vicinity of the reference level by the ACC loop if the carrier chrominance signal 2a of low amplitude is inputted. On the contrary, if the carrier chrominance signal 2a of high amplitude is inputted, the ACC wave detection signal 4 is also pulled in the pull-in range in the vicinity of the reference level by the ACC loop.

In that case, the signal 4 is pulled in a path of symbols (1′), (2′) and (3′) as inversion of the symbols (1), (2) and (3) in FIG. 3 about the origin 0, for example.

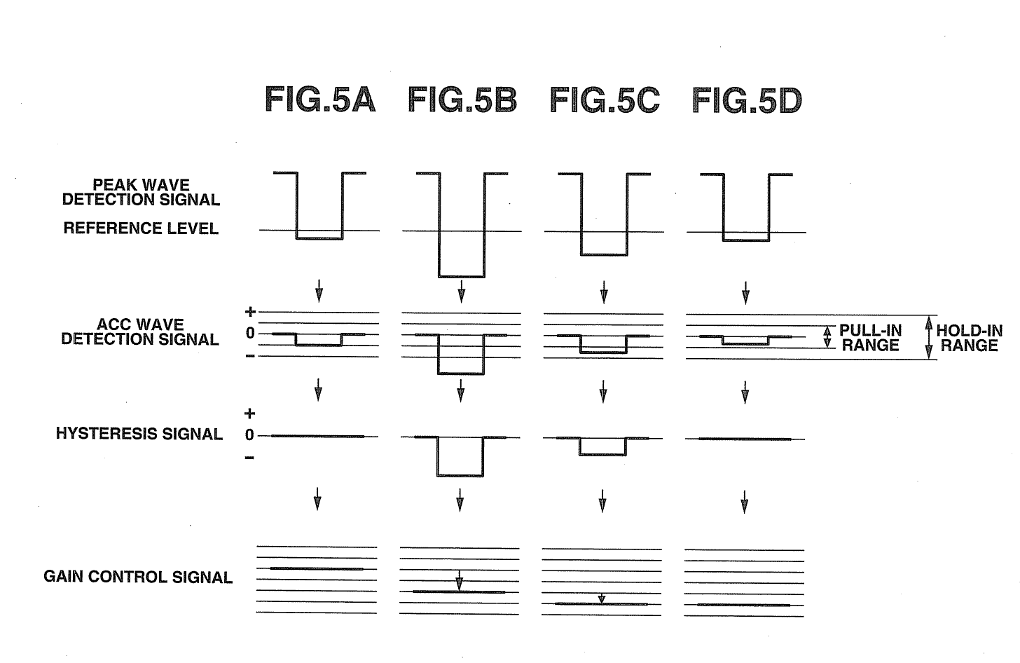

The ACC circuit 1 performs, as the integrating circuit 18, integration on an arbitrary cycle not less than a horizontal interval, so that a quick response to a change in each horizontal interval can be realized. Further, the response does not decrease even in the pull-in range. The following will describe a specific example with reference to FIGS. 5A to 5D.

Next, the operation of the ACC circuit 1 will be described with reference to FIGS. 5A to 5D if the amplitude of the carrier chrominance signal 2a significantly changes due to switching of a reception channel while the ACC wave detection signal 4 is within the pull-in range.

FIG. 5A is equivalent to the state of the symbol (3′) in FIG. 3, for example. In the state, the peak wave detection signal 16 is slightly larger than the reference level, for example. The ACC wave detection signal 4 in this case is within the pull-in range and the hysteresis signal 6 is 0, as shown in FIG. 5A.

In the above state, suppose that the peak wave detection signal 16 changes so as to be larger than the reference level as shown in FIG. 5B due to switching of a reception channel by a user, for example.

The ACC wave detection signal 4 in this case is equivalent to the symbol (1′) on the outside of the hold-in range in FIG. 3, for example. In that case, the hysteresis signal 6 of a negative value corresponding to the level of the ACC wave detection signal 4 is generated.

According to the hysteresis signal 6, the gain control signal 19 in the previous cycle is decreased. Accordingly, the peak wave detection signal 16 gets closer to the reference level than in FIG. 5B, as shown in FIG. 5C. The ACC wave detection signal 4 in this case is, for example, within the hold-in range. However, if the signal 4 is on the outside of the pull-in range, the signal 4 is equivalent to the symbol (2′) in FIG. 3, for example.

Also in the above case, the hysteresis signal 6 of a negative value corresponding to the level of the ACC wave detection signal 4 is generated.

According to the hysteresis signal 6, the gain control signal 19 in the previous cycle is decreased. Accordingly, the peak wave detection signal 16 gets closer to the reference level than in FIG. 5C, as shown in FIG. 5D. The ACC wave detection signal 4 in this case is, for example, within the pull-in range. The ACC wave detection signal in this case corresponds to the symbol (3′) in FIG. 3, for example. As such, the hysteresis signal 6 becomes 0 and keeps the state in FIG. 5D after that.

If the change of the amplitude in the state in FIG. 5A is not so high as in FIG. 5B, the change can be as shown in FIGS. 5A to 5C. Also in this case, the signal is pulled in the state in FIG. 5D by the ACC loop.

As described with reference to FIGS. 5A to 5D, the ACC circuit 1 according to the present embodiment has a merit that the responsiveness of the circuit 1 does not decrease even after entering the pull-in range.

FIG. 5B illustrates the case that the peak wave detection signal 16 largely changes beyond the reference level. However, the peak wave detection signal 16 can change so as to be smaller than the reference level. For example, the signal 16 can change from the state at the symbol (3) in FIG. 3 to that at a symbol (5) or a symbol (4). Also in this case, the circuit 1 operates by the ACC loop such that the ACC wave detection signal 4 is within the pull-in range in an almost the same way as described in relation to FIG. 4A and others.

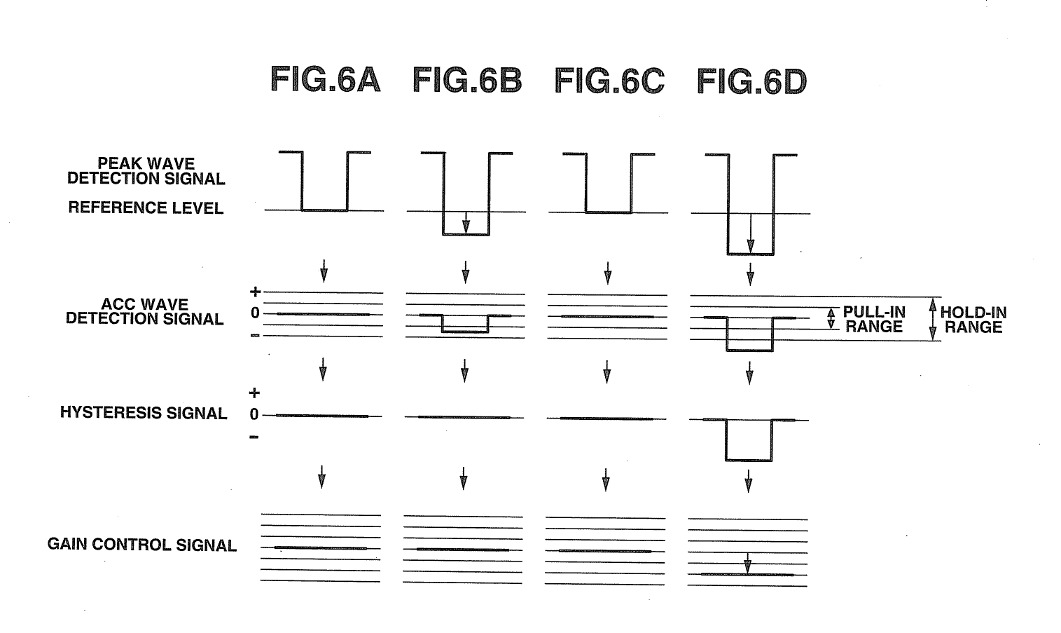

FIGS. 6A to 6D illustrate the operation on the influence of a single-shot noise in the ACC circuit 1.

FIG. 6A illustrates waveforms of the respective units in the state where the peak wave detection signal 16 is nearly equal to the reference level, i.e., the state where the ACC wave detection signal 4 is within the pull-in range.

In the above state, the ACC wave detection signal 4 inputted to the hysteresis signal generating unit 7 is equivalent to near the origin 0 in FIG. 3, in which the hysteresis signal 6 is 0 while the gain control signal 19 keeps the value in the previous cycle.

In that state, if a single-shot noise occurs in a burst signal, the peak wave detection signal 16 by the peak wave detecting circuit 14 exceeds the reference level, as shown in FIG. 6B.

Accordingly, the ACC wave detection signal 4 has the negative polarity as shown in FIG. 6B and is inputted to the hysteresis signal generating unit 7.

In the present embodiment, the hold-in range for the single-shot noise that has occurred in the burst signal, for example, for large part of the single-shot noise, is set (adjusted) such that the value of the ACC wave detection signal 4 in that case is within the hold-in range of the hysteresis signal generating unit 7.

If the single-shot noise satisfies the above condition (the single-shot noise shown in FIG. 6B is equivalent to the symbol (4′) in FIG. 3, for example), the hysteresis signal 6 retains to be 0 as shown in FIG. 6B. Accordingly, the gain control signal 19 is also the same value as in FIG. 6A.

Then, if the circuit 1 returns to the state with no single-shot noise as shown in FIG. 6C, the circuit 1 operates in the same state as in FIG. 6A to keep the stable operation.

If a large single-shot noise occurs in the state in FIG. 6C that does not satisfy the above condition as shown in FIG. 6D, the ACC wave detection signal 4 becomes negative. Accordingly, the level of the gain control signal 19 decreases, thereby decreasing the gain in the ACC amplifier circuit 11.

According to the above, afterwards, the ACC loop operation functions to decrease the peak value of the peak wave detection signal 16 so as to set the ACC wave detection signal 4 within the pull-in range (in approximately the same way as shown in FIG. 5B and the following drawings, although not shown in FIGS. 6A to 6D).

As described above, the ACC circuit 1 according to the present embodiment has a highly-responsive and stable auto color control function.

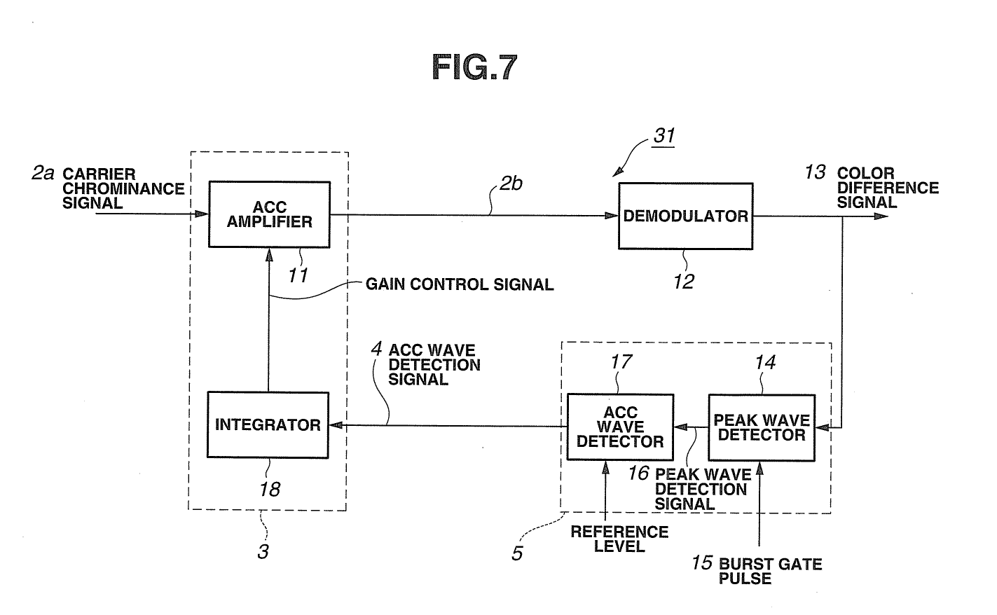

As described above, the ACC circuit 1 according to the present embodiment is provided with the hysteresis signal generating unit 7. On the other hand, FIG. 7 illustrates configuration of an ACC circuit 31 as a reference example of the ACC circuit 1 that is not provided with the hysteresis signal generating unit 7.

In the ACC circuit 31 in the reference example, the ACC wave detection signal 4 from the ACC wave detecting unit 5 is inputted to the integrating circuit 18 of the gain varying unit 3. An integration output of the signal 4 is applied as a gain control signal to the ACC amplifier circuit 11. Other components of the ACC circuit 31 in the reference example are similar to those in FIG. 2 and will not be further described herein.

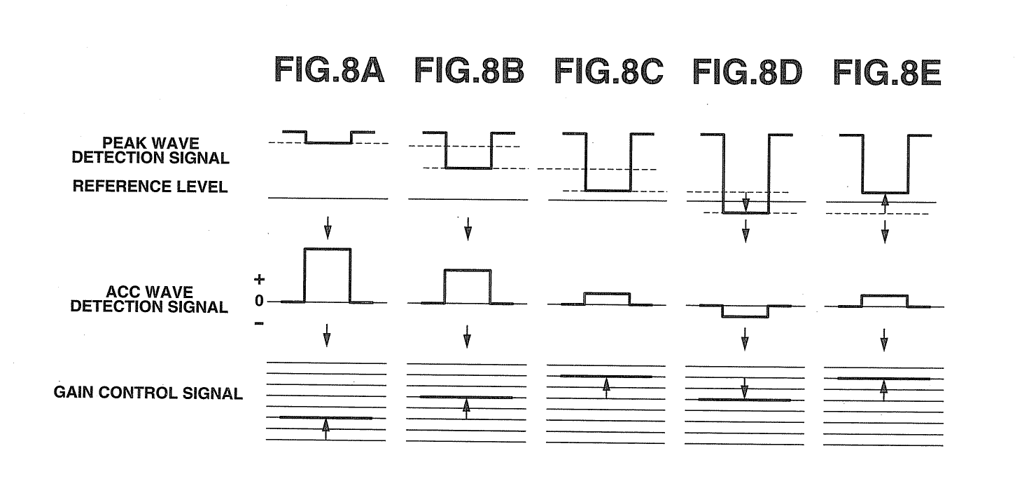

In the ACC circuit 31, a transient response of the ACC loop occurs due to insufficient gain control accuracy as shown in FIGS. 8A to 8E, for example.

First, in the state in FIG. 8A, the peak wave detection signal 16 has not reached the reference level, that is, the gain of the ACC amplifier circuit 11 is insufficient.

In that state, the ACC wave detection signal 4 is outputted as a positive value, and increases the gain control signal 19 by the integrating circuit 18, so that the signal 6 serves to increase the gain in the ACC amplifier circuit 11. As a result, the amplitude of the peak wave detection signal 16 becomes higher in the next cycle as in FIG. 8B.

However, the circuit 31 operates to increase the gain in the ACC amplifier circuit 11 similarly to the operation described before because the signal 16 has not reached the reference level yet, and transits to FIG. 8C. The signal 16 has not reached the reference level also in the state, so that the gain in the ACC amplifier circuit 11 further increases and transits to FIG. 8D.

In FIG. 8D, the peak wave detection signal 16 is higher than the reference level and the ACC wave detection signal 4 is extracted as a negative value. As such, a gain control signal becomes lower than in the previous cycle (the state in FIG. 8C) and operates to decrease the gain in the ACC amplifier circuit 11, then transits to FIG. 8E. In FIG. 8E, the peak wave detection signal 16 does not reach the reference level again, so that the signal operates to increase the gain of the ACC amplifier circuit 11. Afterwards, the states in FIGS. 8D and 8E are kept.

As described above, the peak wave detection signal 16 transits over and below the reference level instead of staying at the reference level, so that the amplitude of a color difference signal varies. Accordingly, the color strength on a screen continues to change similarly, thereby a phenomenon occurs that is generally referred to as an ACC flicker.

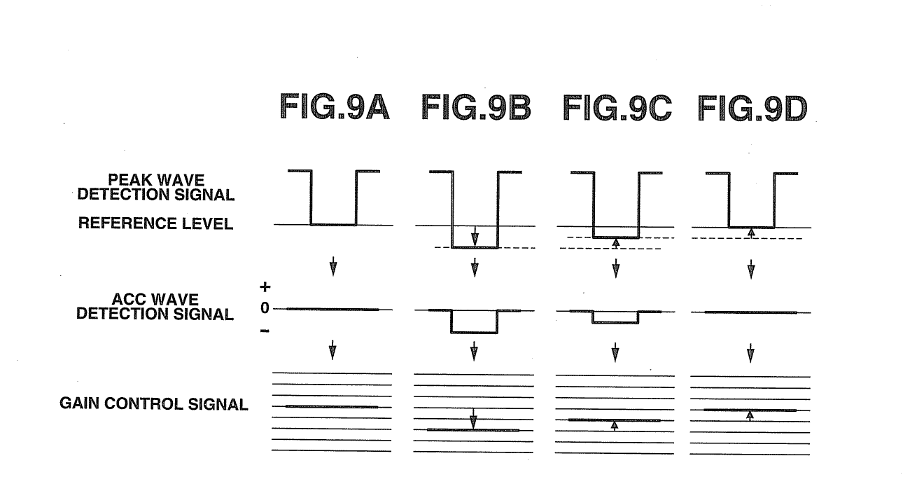

FIGS. 9A to 9D illustrate a response of the ACC loop in a reference example when a burst signal of the carrier chrominance signal 2a is influenced by a single-shot noise.

FIG. 9A illustrates the state where the ACC loop is stable. FIG. 9B illustrates the state where the carrier chrominance signal 2a influenced by the single-shot noise is demodulated and the amplitude of the peak wave detection signal 16 of which peak wave is detected is high.

In the above state, a gain control signal operates to decrease the gain. The influence of the single-shot noise still remains in FIG. 9C, and the amplitude turns back to the original in FIG. 9D. In this way, the influence of the single-shot noise remains over a number of cycles, so that an ACC flicker occurs.

On the other hand, the ACC circuit 1 described above according to the present embodiment can effectively prevent the occurrence of an ACC flicker.

The ACC wave detection signal 4 may be controlled as described below to be surely pulled from the outside of the pull-in range in the pull-in range by applying the gain control signal 19 to the ACC amplifier circuit 11 and variably controlling the gain of the signal 19.

Describing in detail, if, for example, the ACC loop gain is large the ACC wave detection signal 4 on the outside of the pull-in range can change by the ACC loop, for example, from the symbol (1) in FIG. 3 to a symbol (7) on the outside of the pull-in range on the other side beyond the pull-in range via a symbol (6).

In the above process, it takes time to pull a signal in the pull-in range.

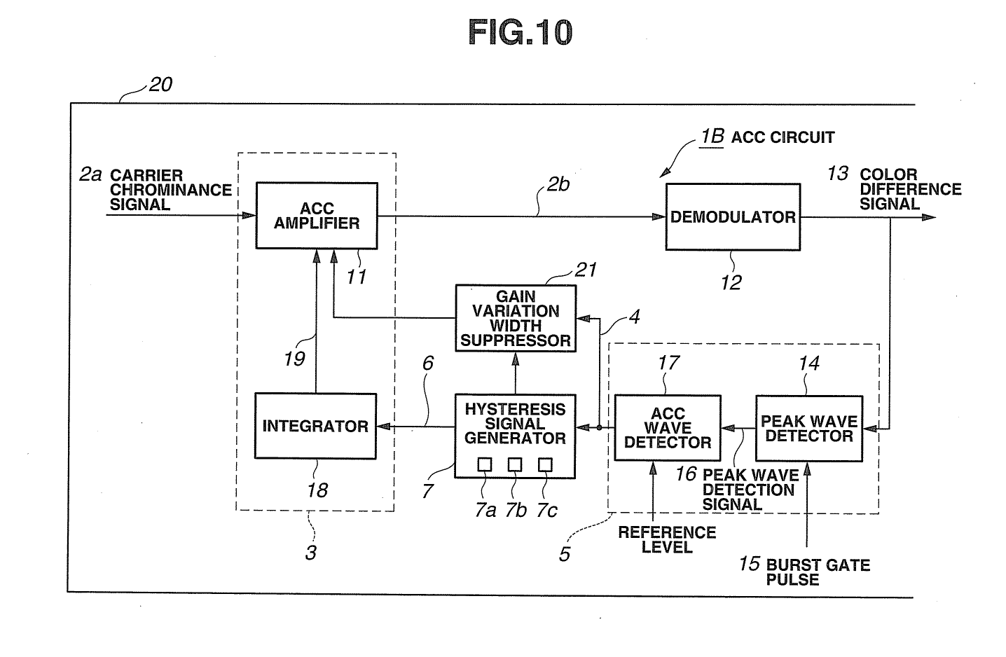

In order to prevent the above situation, an ACC circuit 1B may be configured as shown in FIG. 10, for example. FIG. 10 illustrates configuration of the ACC circuit 1B provided in a color signal processing circuit 20 according to a variation.

The ACC circuit 1B further includes a gain variation width suppressing circuit 21 configured to suppress the variation width of the gain in an ACC amplifier 11 in the ACC circuit 1 in FIG. 2.

In FIG. 10, a low-pass filter (referred to as an LPF) 18B is employed instead of the integrating circuit 18 in FIG. 2. A low-pass component of the hysteresis signal 6 through the LPF 18B is applied as the gain control signal 19 to the ACC amplifier 11.

The gain variation width suppressing circuit 21 monitors the state that the ACC wave detection signal 4 has reached, for example, from a remote point on the outside of the pull-in range to the vicinity of or around the pull-in range (for example, the state near the symbol (6) in FIG. 3).

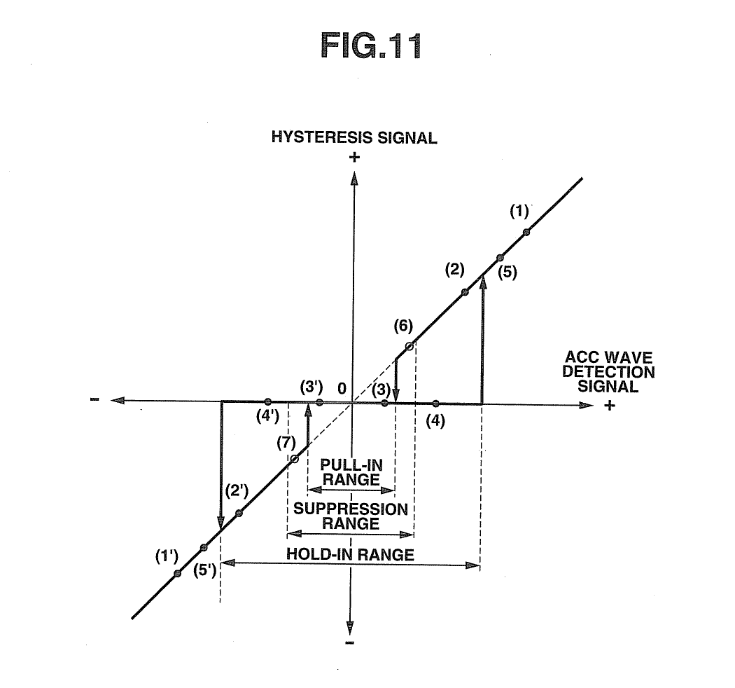

Specifically, the gain variation width suppressing circuit 21 monitors whether or not the ACC wave detection signal 4 has moved from the outside of the pull-in range into a gain variation suppression range (hereinafter, referred to as a suppression range) near the pull-in range, as shown in FIG. 11.

The suppression range is set, for example, between the pull-in range and the hold-in range at least near the pull-in range on the outside of the pull-in range (for example, the median value of the hold-in range).

To the gain variation width suppressing circuit 21, a signal of the past hysteresis determination result is inputted also from the hysteresis signal generating unit 7.

If the ACC wave detection signal 4 is in the suppression range near the pull-in range, the suppressing circuit 21 outputs a suppression signal to suppress the variation width of the gain in the ACC amplifier circuit 11 by the gain control signal 19 to the ACC amplifier 11, for example.

This can suppress the variation width of the ACC wave detection signal 4 so as not to change to the outside of the pull-in range on the other side beyond the pull-in range, thereby pulling in the ACC wave detection signal 4 into the pull-in range more smoothly and certainly.

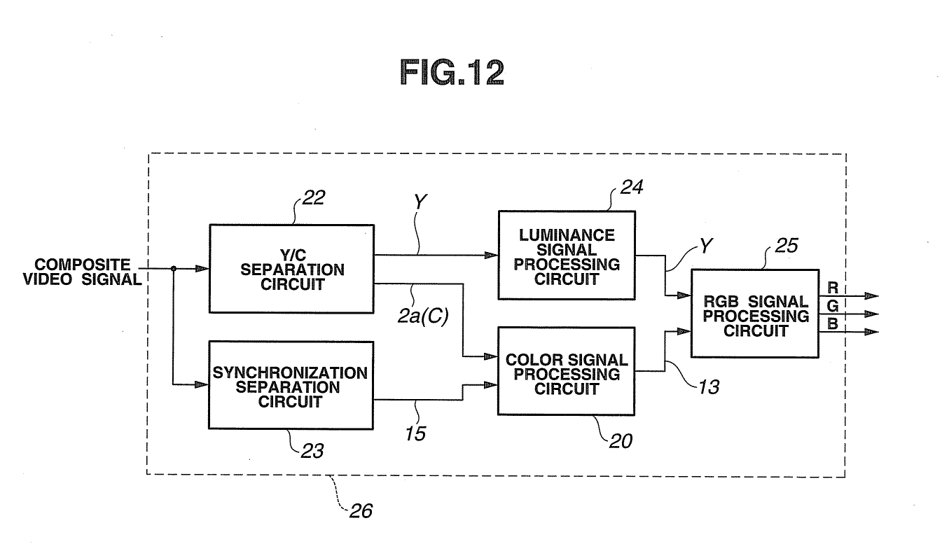

FIG. 12 is a block diagram illustrating a configuration example of a video signal processing circuit 26 including the color signal processing circuit 20.

A composite video signal inputted to the video signal processing circuit 26 is inputted to a Y/C separation circuit 22 and a synchronization separation circuit 23. The Y/C separation circuit 22 separates the composite video signal to a luminance signal Y and a carrier color signal C (indicated here by symbol 2a).

The luminance signal Y is inputted to a luminance signal processing circuit 24. The carrier color signal 2a is inputted to the gain varying unit 3 (see FIG. 10) in the color signal processing circuit 20.

The synchronization separation circuit 23 separates and extracts a horizontal and vertical synchronization signal from the composite video signal, and further generates the burst gate pulse 15 synchronized with the burst signal. The burst gate pulse 15 is inputted to the ACC wave detecting unit 5 (see FIG. 10) in the color signal processing circuit 20.

The luminance signal Y subjected to a processing such as profile emphasis by the luminance signal processing circuit 24 is inputted to an RGB signal processing circuit 25. To the RGB signal processing circuit 25, the color difference signal 13 outputted from the color signal processing circuit 20 is also inputted. The RGB signal processing circuit 25 generates an RGB signal, which is comprised of color component signals RGB, from the luminance signal Y and the color difference signal 13.

The example has been described in relation to FIG. 10 that the gain variation suppressing circuit 21 is provided on the outside of the hysteresis signal generating unit 7. However, for means or a method of suppressing the variation width of the gain control signal 19, a suppression range may be set as a third range in addition to the pull-in range and the hold-in range in the hysteresis signal generating unit 7, for example.

If the ACC wave detection signal 4 is in the suppression range in the process in which the ACC wave detection signal 4 changes from the outside of the hold-in range into the hold-in range by the ACC loop, the hysteresis signal generating unit 7 outputs a gain variation suppression signal to suppress (limit) the change amount of the gain control signal 19 to be not more than a set value, according to a detection signal in the range.

Alternatively, the hysteresis signal generating unit 7 may suppress the variation width of the hysteresis signal 6 outputted from the hysteresis signal generating unit 7.

The above control suppresses the change of the ACC wave detection signal 4 beyond the pull-in range and pulls the ACC wave detection signal 4 in the pull-in range smoothly and certainly. When the signal 4 is in the pull-in range, the hysteresis signal generating unit 7 releases the gain variation suppression. This can prevent decrease of the speed of a response to switching of a reception channel.

The ACC circuit 1 can be configured not only as an analog circuit, but also as a digital circuit. In that case, the ACC amplifier circuit 11 to which the digital carrier chrominance signal 2a is inputted is configured as a multiplier (or a divider), for example.

The integrating circuit 18 can be configured, for example, as an up/down counter circuit configured to add or subtract (counts up/down) a digital hysteresis signal outputted from the digital hysteresis signal generating unit 7 and to output the count output as a gain control signal to the multiplier in each horizontal interval.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An auto color control circuit comprising:
an auto color control wave detecting unit configured to detect amplitude of a burst signal contained in a carrier chrominance signal and to output the amplitude as an auto color control wave detection signal;
a hysteresis signal generating unit configured to output a hysteresis signal having hysteresis characteristics depending on level of said auto color control wave detection signal; and
a gain varying unit configured to variably control gain of said carrier chrominance signal according to said hysteresis signal.

2. The auto color control circuit according to claim 1, wherein:
when said hysteresis signal generating unit performs said hysteresis control, said hysteresis signal generating unit sets said hysteresis signal to zero when said auto color control wave detection signal changes from outside of a first range, which is set above and below a reference value, to inside of the first range.

3. The auto color control circuit according to claim 2, wherein:
when said hysteresis signal generating unit performs said hysteresis control, said hysteresis signal is set to zero when said auto color control wave detection signal changes from the inside of said first range to inside of a second range, which is set on the outside of said first range based on said reference value, and said hysteresis signal changes depending on the level of the auto color control wave detection signal when said auto color control wave detection signal changes from the inside of said second range to outside of the second range.

4. The auto color control circuit according to claim 1, further comprising:
a demodulating unit configured to demodulate an output signal of said gain varying unit.

5. The auto color control circuit according to claim 4, further comprising:
a wave detecting circuit configured to detect the amplitude of a burst signal contained in the color difference signal demodulated by said demodulating unit.

6. The auto color control circuit according to claim 5, wherein:
said wave detecting circuit comprises a peak value wave detecting circuit configured to detect a peak value of said burst signal to detect the amplitude of said burst signal.

7. The auto color control circuit according to claim 5, further comprising:
an auto color control wave detecting circuit configured to compare an output signal of said wave detecting circuit to a reference value to output an auto color control wave detection signal corresponding to deviation from the reference value.

8. The auto color control circuit according to claim 1, further comprising:
an integrating circuit configured to integrate said hysteresis signal on a pre-determined cycle,
wherein the auto color control circuit variably controls the gain in said gain varying unit using said hysteresis signal integrated by the integrating circuit as a gain control signal.

9. The auto color control circuit according to claim 8, wherein:
said integrating circuit cycle can be set around a horizontal interval.

10. The auto color control circuit according to claim 1, further comprising:
a low-pass filter circuit configured to pass through a low-pass component in said hysteresis signal,
wherein the auto color control circuit variably controls gain in said gain varying unit using said low-pass component in said hysteresis signal passed through the low-pass filter circuit as a gain control signal.

11. The auto color control circuit according to claim 1, wherein a closed loop is formed by:
said gain varying unit to which said carrier chrominance signal is inputted; said auto color control wave detecting unit to which an output signal of the gain varying unit or an output signal of a demodulating unit configured to perform demodulation is inputted; and a hysteresis signal generating unit to which an output signal of the auto color control wave detecting unit is inputted and which controls the gain of said gain varying unit.

12. The auto color control circuit according to claim 2, wherein a closed loop is formed by:
said gain varying unit to which said carrier chrominance signal is inputted; said auto color control wave detecting unit to which an output signal of the gain varying unit or an output signal of a demodulating unit configured to perform demodulation is inputted; and a hysteresis signal generating unit to which an output signal of the auto color control wave detecting unit is inputted and which controls the gain of said gain varying unit.

13. The auto color control circuit according to claim 3, wherein a closed loop is formed by:
said gain varying unit to which said carrier chrominance signal is inputted; said auto color control wave detecting unit to which an output signal of the gain varying unit or an output signal of a demodulating unit configured to perform demodulation is inputted; and a hysteresis signal generating unit to which an output signal of the auto color control wave detecting unit is inputted and which controls the gain of said gain varying unit.

14. The auto color control circuit according to claim 11, wherein:
said closed loop operates to automatically control amplitude of the output signal of said gain varying unit or said demodulating unit on a pre-determined cycle around a horizontal interval.

15. The auto color control circuit according to claim 2, wherein:
said hysteresis signal generating unit comprises a detecting unit configured to detect change of said auto color control wave detection signal from the outside of said first range into inside of a third range which is set on the outside of the first range near the first range.

16. The auto color control circuit according to claim 15, wherein:
if said auto color control wave detection signal detects the change into the inside of third range, said detecting unit suppresses the gain variation width in said gain varying unit.

17. A video signal processing circuit comprising an auto color control circuit comprising:
an auto color control wave detecting unit configured to detect amplitude of a burst signal contained in a carrier chrominance signal and to output the amplitude as an auto color control wave detection signal;
a hysteresis signal generating unit configured to output a hysteresis signal having hysteresis characteristics depending on level of said auto color control wave detection signal; and
a gain varying unit configured to variably control gain of said carrier chrominance signal according to said hysteresis signal.

18. The video signal processing circuit according to claim 17, wherein:
when said hysteresis signal generating unit performs said hysteresis control, said hysteresis signal generating unit sets said hysteresis signal to zero when said auto color control wave detection signal changes from outside of a first range, which is set above and below a reference value, to inside of the first range.

19. The video signal processing circuit according to claim 17, wherein:
when said hysteresis signal generating unit performs said hysteresis control, said hysteresis signal is set to zero when said auto color control wave detection signal changes from the inside of said first range to inside of a second range, which is set on the outside of said first range based on said reference value, and said hysteresis signal changes depending on the level of the auto color control wave detection signal when said auto color control wave detection signal changes from the inside of said second range to outside of the second range.

20. The video signal processing circuit according to claim 17, wherein:
said auto color control wave detecting unit comprises: a demodulating unit configured to demodulate an output signal of said gain varying unit; a wave detecting circuit configured to detect amplitude of the burst signal contained in the color difference signal demodulated by said demodulating unit; and an auto color control wave detecting circuit configured to compare an output signal of said wave detecting circuit to a reference value and to output an auto color control wave detection signal corresponding to deviation from the reference value.
